(19) United States
(12) Patent Application Publication
(10) Pub. No.: US 2018/0260084 A1
(43) Pub. Date: Sep. 13, 2018

(54) INFORMATION PROCESSING APPARATUS, DISPLAY, DISPLAY SYSTEM, AND NON-TRANSITORY COMPUTER READABLE MEDIUM

(71) Applicant: FUJI XEROX CO., LTD., Tokyo (JP)

(72) Inventor: Masanori SATAKE, Kanagawa (JP)

(73) Assignee: FUJI XEROX CO., LTD., Tokyo (JP)

(21) Appl. No.: 15/711,164

(22) Filed: Sep. 21, 2017

(30) Foreign Application Priority Data
Mar. 9, 2017 (JP) 2017-045427

(51) Int. Cl. G06F 3/0483; G06F 3/0481; G06F 17/30

(52) U.S. Cl. CPC G06F 3/0483; G06F 3/04842; G06F 17/30884; G06F 3/0481

(57) ABSTRACT

An information processing apparatus includes a selection information receiving unit that receives selection information indicating that a user has selected plural window screens and/or tab screens, a display status acquisition unit that acquires a display status regarding each of the selected window screens and/or tab screens, and a restoring unit that restores and displays each of the window screens and/or tab screens in the display status when the user selects a registration unit that has registered each of the acquired display statuses.

### CROSS-REFERENCE TO RELATED APPLICATIONS

This application is based on and claims priority under 35 USC 119 from Japanese Patent Application No. 2017-045427 filed Mar. 9, 2017.

### BACKGROUND

### (i) Technical Field

The present invention relates to an information processing apparatus, a display, a display system, and a non-transitory computer readable medium.

### (ii) Related Art

Plural services are typically provided by opening plural window screens or plural tab screens in application software, such as a browser. Information related to service is registered on a registration unit, such as a bookmark, and by selecting the registration unit, a window screen or a tab screen responsive to the registered service is re-displayed.

### SUMMARY

According to an aspect of the invention, there is provided an information processing apparatus. The information processing apparatus includes a selection information receiving unit that receives selection information indicating that a user has selected plural window screens and/or tab screens, a display status acquisition unit that acquires a display status regarding each of the selected window screens and/or tab screens, and a restoring unit that restores and displays each of the window screens and/or tab screens in the display status when the user selects a registration unit that has registered each of the acquired display statuses.

### BRIEF DESCRIPTION OF THE DRAWINGS

Exemplary embodiment of the present invention will be described in detail based on the following figures, wherein:

FIG. 1 illustrates a configuration of a display process system in accordance with an exemplary embodiment;

FIG. 2A illustrates plural window screens displayed on a display screen of a display, and FIG. 2B illustrates plural tab screens displayed on the display screen of the display;

FIG. 3 is a block diagram illustrating a functional configuration of an information processing apparatus of the exemplary embodiment;

FIG. 4A and FIG. 4B illustrate first examples of an entry screen on which a user selects a window screen;

FIG. 5 illustrates a second example of the entry screen on which the user selects a window screen;

FIG. 6 illustrates information regarding a bookmark to be registered;

FIG. 7A and FIG. 7B illustrate a method through which a display status modifying unit modifies a display status;

FIG. 8 is a flowchart illustrating a process which registers a display status as information regarding the bookmark, from among processes of the information processing apparatus;

FIG. 9 is a flowchart illustrating the operation in step S108 of FIG. 8 in more detail;

FIG. 10 is a flowchart illustrating the operation in step S109 of FIG. 8 in more detail; and

FIG. 11 is a flowchart illustrating a process which restores and displays window screens and tab screens in accordance with a display status registered in the information of bookmarks, from among the processes of the information processing apparatus.

### DETAILED DESCRIPTION

An exemplary embodiment of the present invention is described with reference to the drawings.

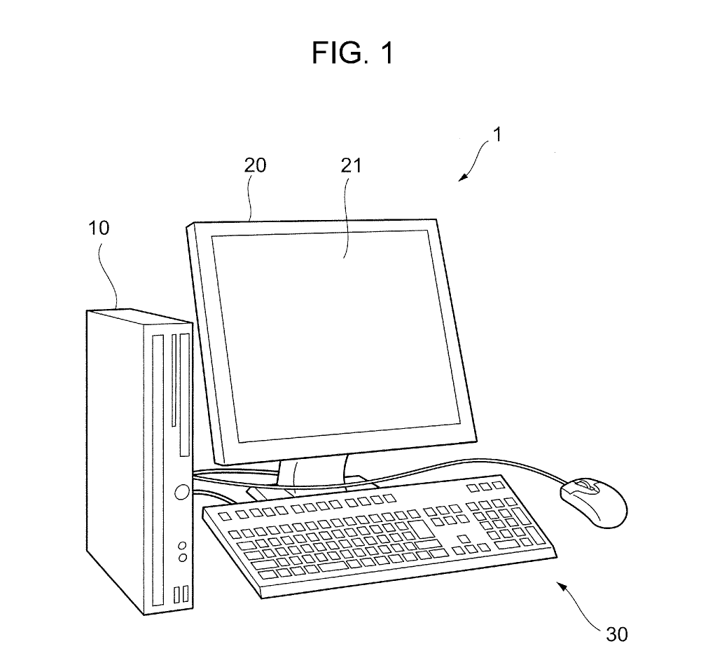

FIG. 1 illustrates a configuration of a display system 1 in accordance with an exemplary embodiment.

The display process system 1 as illustrated in FIG. 1 includes an information processing apparatus 10 that creates image information of an image to be displayed on a display 20, the display 20 that receives the image information created by the information processing apparatus 10 and displays the image in accordance with the image information, and an input device 30 through which a user enters a variety of information to the information processing apparatus 10.

The image processing apparatus 10 is a general-purpose personal computer (PC), for example. The image processing apparatus 10, controlled by an operating system (OS), causes a variety of software applications to run, thereby creating the image information.

The display 20 displays an image on a display screen 21 as a display unit. The display 20 includes a device that displays an image in additive color mixing. For example, the display 20 may be a liquid-crystal display for the PC, a liquid-crystal television receiver, or a projector. The display method of the display 20 is not limited to a liquid-crystal system. Referring to FIG. 1, the display 20 includes the display screen 21. If a projector is used for the display 20, the display screen 21 is a screen mounted external to the display 20.

The input device 30 includes a keyboard and a mouse. The input device 30 is used to start up or end a software application. As described in detail below, the input device 30 is also used to input to application software, such as a browser, a command to select a bookmark.

The image processing apparatus 10 and the display 20 are connected to each other via a digital visual interface (DVI). The two apparatuses may also be connected to each other via a high-definition multimedia interface (HDMI (registered trademark)) or DisplayPort in place of the DVI.

The image processing apparatus 10 and the input device 30 are connected to each other via a universal serial bus (USB). The two apparatuses may also be connected via an IEEE1394 cable or an RS-232C cable in place of the USB.

The image processing system 1 of the exemplary embodiment is not limited to the configuration of FIG. 1. For example, a tablet terminal may be used for the image processing system 1. In such a case, the table terminal includes a touchpanel. The touchpanel displays an image, and receives a command from the user. In other words, the touchpanel functions as the display 20 and the input device 30. Similarly, a touch monitor may be used as an integrated device of the display 20 and the input device 30. In the exemplary embodiment, a touchpanel is used for a display screen 21 of the display 20. The image processing apparatus 10 creates the image information, and the touch monitor displays an image responsive to the image information. The user inputs a command to perform the image processing by touching the touch monitor.

In the image processing system 1, the user operates the input device 30 to input a command to start application software, such as a browser. In this way, the information processing apparatus 10 starts the browser. The user further operates the input device 30, thereby selecting a desired service by selecting a bookmark. As described in detail below, the user opens a window screen or a tab screen responsive to the service, and displays the window screen or the tab screen on the display 20. The user may interactively use the service while viewing the display 20. The user may thus more intuitively and more easily perform a job.

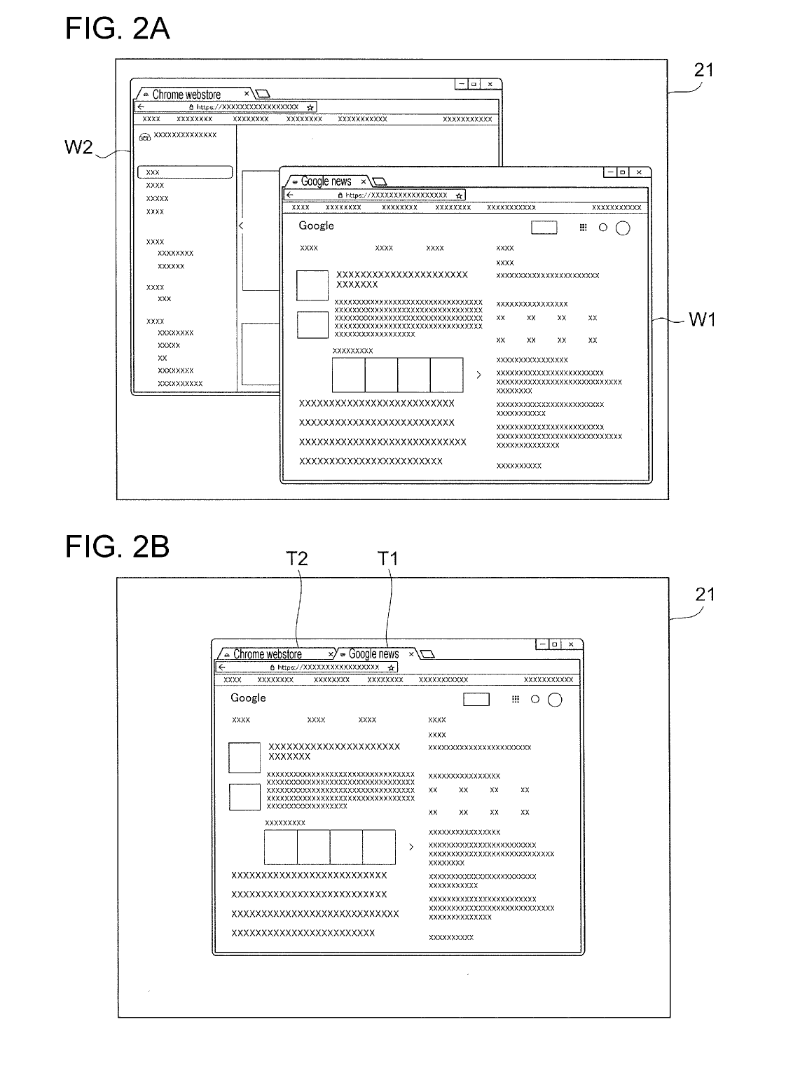

FIG. 2A illustrates plural window screens displayed on the display screen 21 of the display 20.

In the example of FIG. 2A, a browser, used as application software, displays a webpage on the Internet in a service. As illustrated in FIG. 2A, two webpages are displayed on two window screens. One window screen W1 displays a webpage of Google news, and the other window screen W2 displays a webpage of Chrome webstore.

FIG. 2B illustrates plural tab screens displayed on the display screen 21 of the display 20.

Referring to FIG. 2B, a browser, used as application software, displays two webpages in the same manner as in FIG. 2A. However, note that two webpages are displayed on a single window screen. One of the two webpages is a tab screen T1 where a webpage of Google news is displayed, and the other of the two webpages is a tab screen T2 where a webpage of the Chrome webstore is displayed. The two tab screens are switchably selected to display each webpage on the single window screen.

When the plural windows are displayed as illustrated in FIG. 2A, they are displayed without being switched between the tab screens, and the operability of the screens is ensured. On the other hand, the window screens are likely to overlap each other, and the user may be forced to adjust the locations of the window screens.

When the plural tab screens are displayed on a single window screen as illustrated in FIG. 2B, they are free from overlapping as illustrated in FIG. 2A, and the window screen is displayed over a wide area. However, the tab screens are not displayed concurrently, and thus involve a switching operation.

Referring to FIG. 2A and FIG. 2B, the display screen 21 displays plural window screens with a single tab screen or plural tab screens with a single window screen.

Alternatively, the display screen 21 may display both plural window screens and plural tab screens. More specifically, plural window screens are displayed, and plural tab screens are displayed on at least one window screen.

At the end of an operation, some browsers may store an accessed uniform resource locator (URL) and the size and location of a window screen and a tab screen. When the browser starts up the next time, the stored information is restored. In related art, some browsers may store in a bookmark thereof the URL, and the size and location of the window screen and tab screen.

However, stored in the related art are the URL and the display status of the window screen and tab screen (the size and location of the window screen and tab screen) on a per individual service basis. Plural services, namely, information regarding plural window screens and tab screens is not stored. For this reason, the plural window screens and tab screens are not restored. The user thus successively selects bookmarks responsive to services, and restores individually the window screens and tab screens. In the related art, the display statuses allowed to be stored is one type only. No consideration has been given to a display status when plural services are combined. A more appropriate display status is difficult to be stored and restored if plural services are combined.

In the exemplary embodiment, the information processing apparatus 10 configured as described below addresses the problem described above. In accordance with the exemplary embodiment, the information processing apparatus 10 performs control to restore and display plural window screens and tab screens selected from those displayed on the display 20.

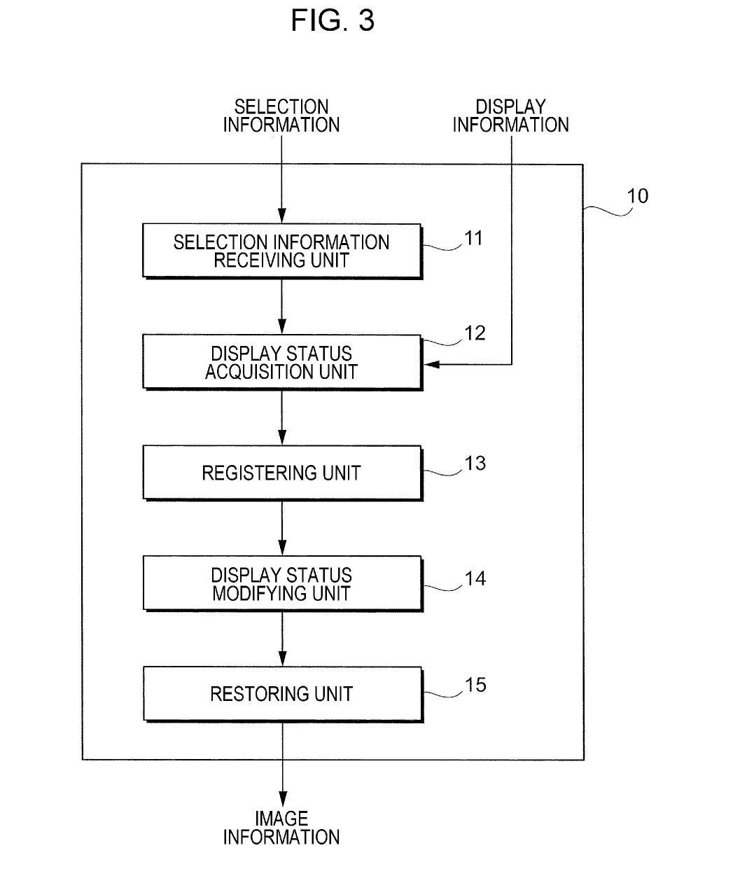

FIG. 3 is a block diagram illustrating a functional configuration of the information processing apparatus 10 of the exemplary embodiment. Note that FIG. 3 illustrates functionalities related to the exemplary embodiment, from among a variety of functionalities of the information processing apparatus 10.

As illustrated in FIG. 3, the information processing apparatus 10 of the exemplary embodiment includes a selection information receiving unit 11, a display status acquisition unit 12, a registering unit 13, a display status modifying unit 14, and a restoring unit 15.

The selection information receiving unit 11 receives a command input to the input device 30 by the user.

In accordance with the exemplary embodiment, the selection information receiving unit 11 receives as selection information the command indicating that the user has selected plural window screens and tab screens.

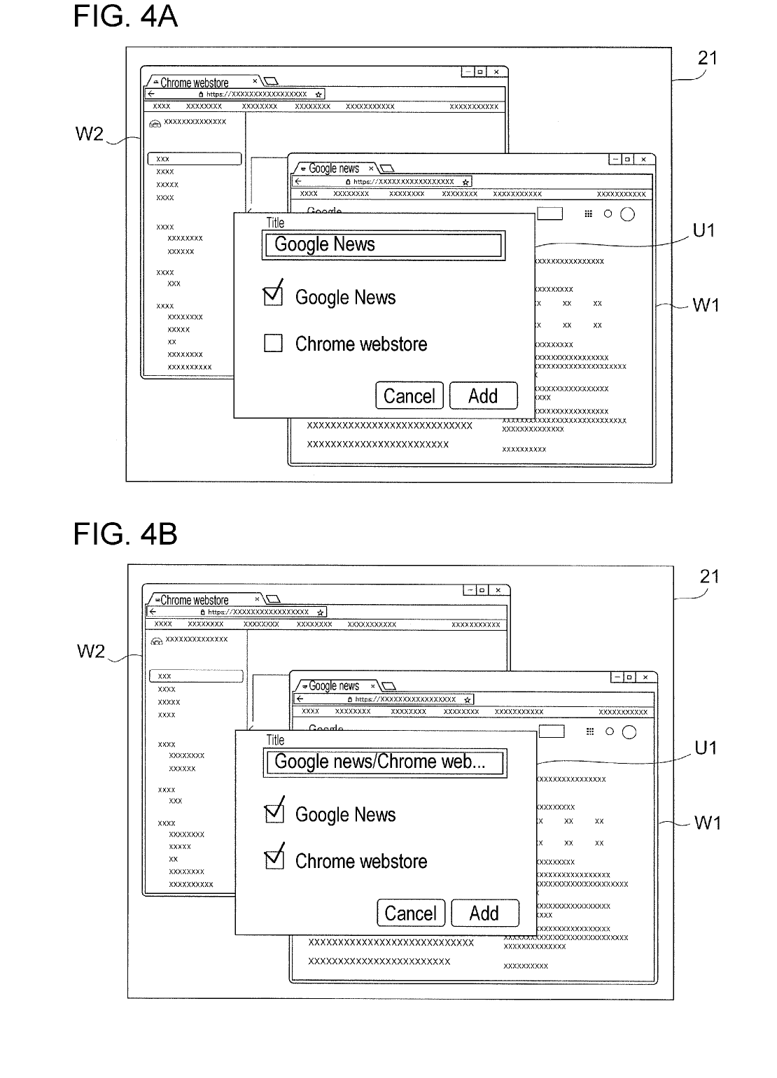

FIG. 4A and FIG. 4B illustrate first examples of entry screens that receive the selection information for the user to select the window screen.

In the examples of FIG. 4A and FIG. 4B, an entry screen U1 that receives selection information indicating that the user has selected the window screen is displayed. In this case, the entry screen U1 is displayed on the screen of FIG. 2A.

Referring to FIG. 4A, the window screen of Google news is selected when the user checks a checkbox of the Google news. The title indicates the name of a bookmark to which registration is made. “Google news” is set as the title herein.

Referring to FIG. 4B, two window screens of the Google news and Chrome webstore are selected when the user further checks a checkbox of the Chrome webstore. “Google news/Chrome webstore” is set in the title herein.

The title may be designed to be automatically set in accordance with the checking of the checkbox. More specifically, a checked item is set to be the title, and if there are plural titles, these items corresponding thereto are linked by using the symbol “/”. If the title exceeds a predetermined number of characters, a character string of an excess portion may be replaced with abbreviated characters. In the illustrated example, “ . . . ” is used as abbreviated characters. Referring to FIG. 4B, the title “Google news” is changed to the tile “Google news/Chrome webstore”. In addition to the bookmark having the title “Google news”, a bookmark having the title “Google news/Chrome webstore” may be separately created. The titles are not limited to these, and may be freely changed by the user.

If the user clicks on an add button in the state of FIG. 4B, the selection information receiving unit 11 acquires the selection information of the window screen and tab screen. If the user clicks on a cancel button, the process is suspended, the entry screen disappears and the display screen 21 reverts back to the screen of FIG. 2A.

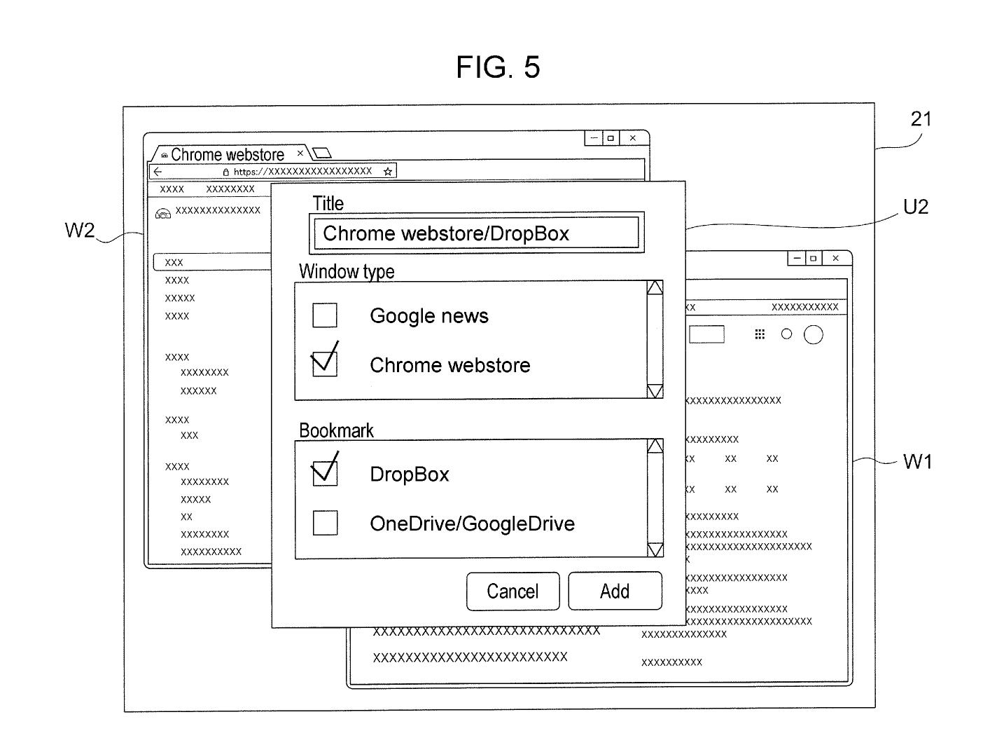

FIG. 5 illustrates a second example of an entry screen U2 on which the user selects a window screen.

In contrast to the entry screen U1 of FIG. 4A and FIG. 4B, the entry screen U2 further displays a screen on which a window screen and tab screen are registered for a registered bookmark.

In the same way as in FIG. 4, the upper portion of the entry screen U2 includes a screen that receives the selection information that the user has selected the window screen. The user herein selects the window screen for the Chrome webstore by checking the checkbox for the Chrome webstore.

The lower portion of the entry screen U2 includes a screen on which the window screen is registered onto a registered bookmark. The user herein selects the bookmark having the title DropBox by checking the checkbox of DropBox. “Chrome webstore/DropBox” is automatically set as the title. In other words, the title “DropBox” is changed to the title “Chrome webstore/DropBox”. Alternatively, as described previously, a bookmark having the title “Chrome webstore/DropBox” may be separately created besides the bookmark having the title “DropBox”. Also, as previously described, the user may freely change the title.

If the user clicks on the add button on each of the screens of FIG. 4A, FIG. 4B, and FIG. 5, the selection information receiving unit 11 acquires the selection information of the window screen and tab screen and the selection information of the bookmark.

Referring back to FIG. 3, the display status acquisition unit 12 acquires the display statuses of the selected window screen and tab screen. As described in more detail below, the display statuses include the window size and location information of the window screen and tab screen.

The registering unit 13 registers each of the acquired statuses in association with a registration unit. The registration unit is a bookmark used in a browser, for example.

If the selection information of the registered bookmark is available as described with reference to FIG. 5, the registering unit 13 registers the display status in association with the bookmark. If the selection information of the bookmark is not available, a new bookmark is created.

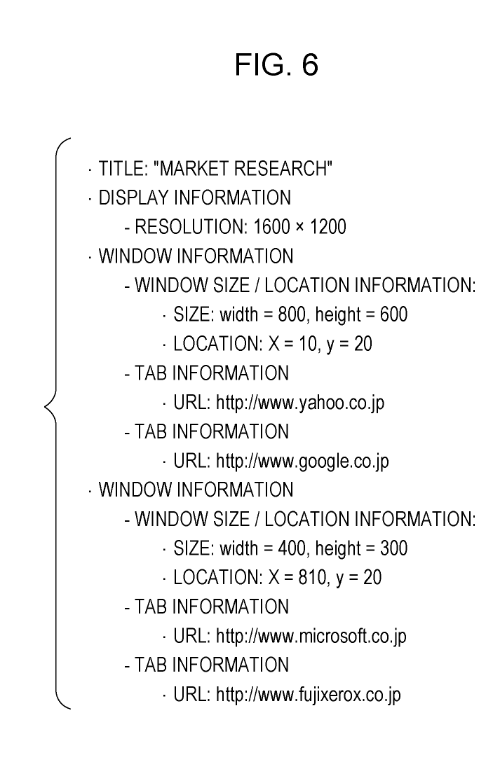

FIG. 6 illustrates information of a registered bookmark.

In the example of FIG. 6, information regarding a bookmark first includes information of a title. The title herein indicates market research. Items of the display status are described below.

The display status includes resolution as display information also serving as information of the size of the display screen 21 in the display 20. The resolution herein is 1600 dots (resolution in the horizontal direction)×1200 dots (resolution in the vertical direction). Two window screens are displayed. The display status includes, as window information related to each of the window screens, a window size expressed by width (the number of dots in the width direction) and height (the number of dots in the height direction), and location information expressed by x (dot coordinate in the horizontal direction) and y (dot coordinate in the vertical direction). Each window screen further includes two tab screens. The window information thus includes URLs as tab information related to each tab screen.

The display status modifying unit 14 modifies the display status in accordance with the display screen 21 that displays the window screen and tab screen. More specifically, the display status modifying unit 14 modifies the display status in accordance with the size of the display screen 21.

If the display 20 is changed, the size of the display screen 21 may also be changed. Inconvenience may occur with the display status of the original window screen and tab screen, and the display status modifying unit 14 accordingly modifies the display status.

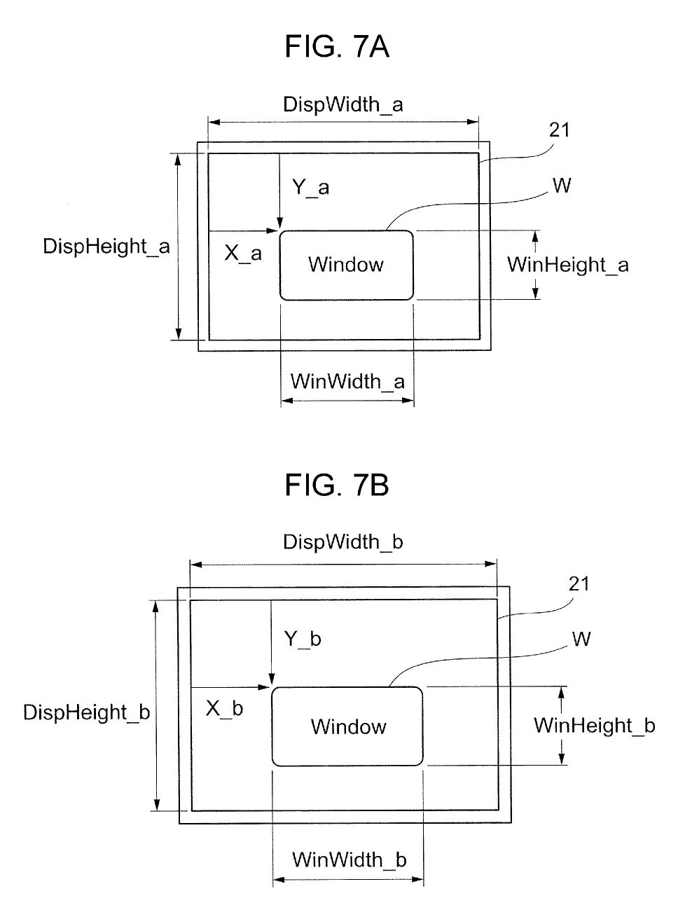

FIG. 7A and FIG. 7B illustrate a method of the display status modifying unit 14 to modify the display status.

FIG. 7A illustrates a window screen W displayed on the display screen 21 after the display status is modified. The size of the display screen 21 is DispWidth_a (width in the horizontal direction) and DispHeight_a (height in the vertical direction). After the display status is modified, the window size is WinWidth_a (width in the horizontal direction) and WinHeight_a (height in the vertical direction). The display screen 21 also indicates the location information of the window screen W after the display status is modified. The location information indicates the coordinates of the top left corner of the window screen W, namely, X_a (coordinate in the horizontal direction), and Y_a (coordinate in the vertical direction). The unit of location and coordinate is pixel.

FIG. 7B illustrates the window screen W displayed on the display screen 21 prior to the modification of the display status. The size of the display screen 21 is DispWidth_b (width in the horizontal direction) and DispHeight_b (height in the vertical direction). Before the display status is modified, the window size of the window screen W is WinWidth_b (width in the horizontal direction) and WinHeight_b (height in the vertical direction). The display screen 21 also indicates the location information of the window screen W before the display status is modified. The location information indicates the coordinates of the top left corner of the window screen W, namely, X_b (coordinate in the horizontal direction), and Y_b (coordinate in the vertical direction).

WinWidth_a, WinHeight_a, X_a, and Y_a are calculated in accordance with formulas (1) through (4). The size and location of the window screen W are modified in accordance with a ratio of the size of the display screen 21 after the size change to the size of the display screen 21 before the size change.

WinWidth_a=WinWidth_b×(DispWidth_a/DispWidth_b) (1)

WinHeight_a=WinHeight_b×(DispHeight_a/DispHeight_b) (2)

X_a=X_b×(DispWidth_a/DispWidth_b) (3)

Y_a=Y_b×(DispHeight_a/DispHeight_b) (4)

The discussion heretofore is based on the premise that the display status registered on the registering unit 13 is modified by the display status modifying unit 14. Alternatively, the display status modifying unit 14 may modify the display status when the display status is registered on the registering unit 13. More specifically, the display status registered on the bookmark is referenced and if the display status that is going to be registered is not different, the registration operation is completed without modifying the display status that has been registered on the bookmark. If the display status that is going to be modified is different, the registration operation is performed by modifying the display status registered on the bookmark.

Referring back to FIG. 3, the restoring unit 15 restores and displays the window screen and tab screen in the display status registered on the registering unit 13 when the user selects the registration unit.

More specifically, if the user selects a bookmark on a browser, the display screen 21 in the display 20 displays the window screen and tab screen that have been restored in the display status registered as the information of the bookmark on the registering unit 13 (restored screens).

The process of the information processing apparatus 10 is described below.

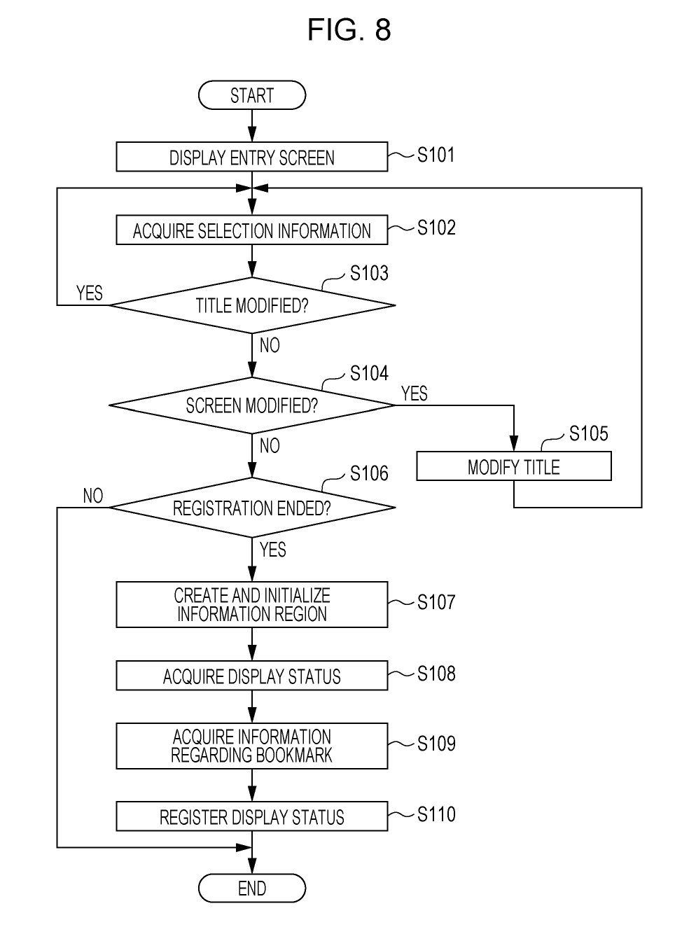

FIG. 8 is a flowchart illustrating the process which registers a display status as information regarding the bookmark, from among the processes of the information processing apparatus 10.

The selection information receiving unit 11 causes the entry screen of FIG. 5 to be displayed (step S101), and acquires the selection information of the window screen and tab screen and the selection information of a bookmark (step S102).

The selection information receiving unit 11 refers to the entry screen of FIG. 5 to determine whether the user has modified the title (step S103).

If the title is modified (yes branch from step S103), the selection information receiving unit 11 returns to step S102.

If the title is not modified (no branch from S103), the selection information receiving unit 11 determines whether the window screen and tab screen (simply referred to as “screen” in FIG. 8) have been modified (step S104). More specifically, the selection information receiving unit 11 determines whether the user has modified the checking on each of the checkboxes on the screens displayed in FIG. 4A, FIG. 4B, and FIG. 5.

If the window screen and tab screen have been modified (yes branch from S104), the selection information receiving unit 11 modifies the title (step S105). The selection information receiving unit 11 then returns to step S102.

If the window screen and tab screen have not been modified (no branch from S104), the selection information receiving unit 11 determines whether the registration of the window screen and tab screen has ended (step S106). This determination step is performed by determining whether the user has clicked on the add button illustrated in FIG. 5.

If the user has clicked on the cancel button instead of the add button (no branch from S106), the selection information receiving unit 11 ends the process.

If the user has clicked on the add button (yes branch from S106), the selection information receiving unit 11 creates and initializes an information region to record information regarding bookmarks on a memory (step S107).

The display status acquisition unit 12 acquires the display status (step S108). The display status is the one described with reference to FIG. 6.

The registering unit 13 acquires the information of bookmarks, based on the selection information of bookmarks acquired in step S102 (step S109). As is described in detail below, the window size described in window information and location information may be modified in accordance with display information (resolution) of the display screen 21 included in the bookmark information. This modification operation is performed by the display status modifying unit 14.

The registering unit 13 registers the display status as the bookmark information (step S110).

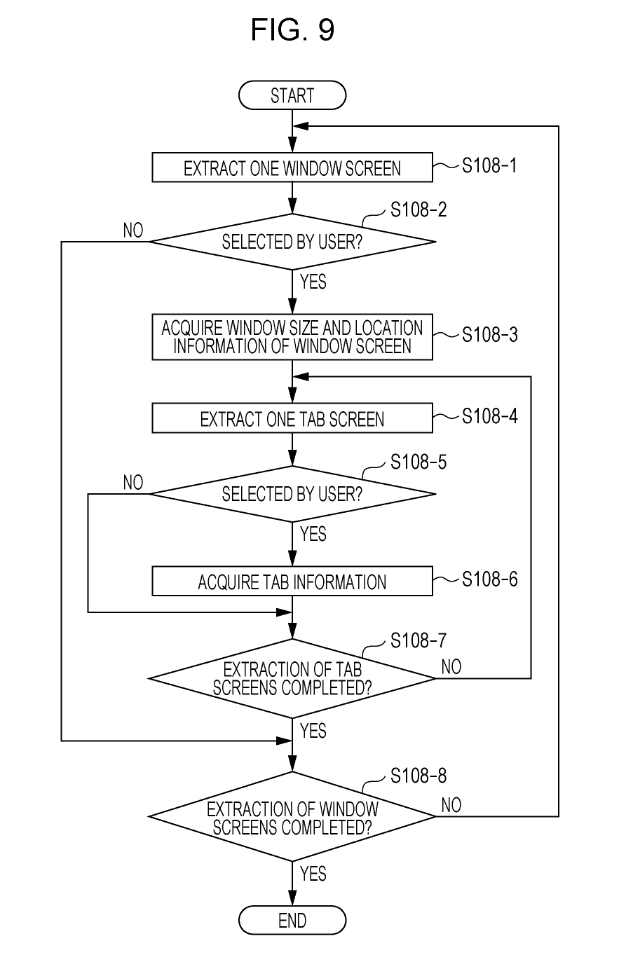

FIG. 9 is a flowchart illustrating the operation in step S108 of FIG. 8 in more detail.

The display status acquisition unit 12 extracts one displayed window screen (step S108-1).

The display status acquisition unit 12 determines whether the window screen is the one selected by the user (step S108-2).

If the window screen is not the one selected by the user (no branch from S108-2), the display status acquisition unit 12 proceeds to step S108-8.

If the window screen is the one selected by the user (yes branch from S108-2), the display status acquisition unit 12 acquires the location information and the window size of the window screen as the window information (step S108-3).

The display status acquisition unit 12 extracts one displayed tab screen (step S108-4).

The display status acquisition unit 12 determines whether the tab screen is the one selected by the user (step S108-5).

If the tab screen is not the one selected by the user (no branch from S108-5), the display status acquisition unit 12 proceeds to step S108-7.

If the tab screen is the one selected by the user (yes branch from S108-5), the display status acquisition unit 12 acquires the tab information as the window information (step S108-6).

The display status acquisition unit 12 determines whether the extraction of the tab screens has been completed (step S108-7).

If the extraction has not been completed (no branch from S108-7), the display status acquisition unit 12 returns to step S108-4.

If the extraction has been completed (yes branch from S108-7), the display status acquisition unit 12 determines whether the extraction of the window screens has been completed (step S108-8).

If the extraction has not been completed (no branch from S108-8), the display status acquisition unit 12 returns to step S108-1.

If the extraction has been completed (yes branch from S108-8), the display status acquisition unit 12 ends the operation in step S108.

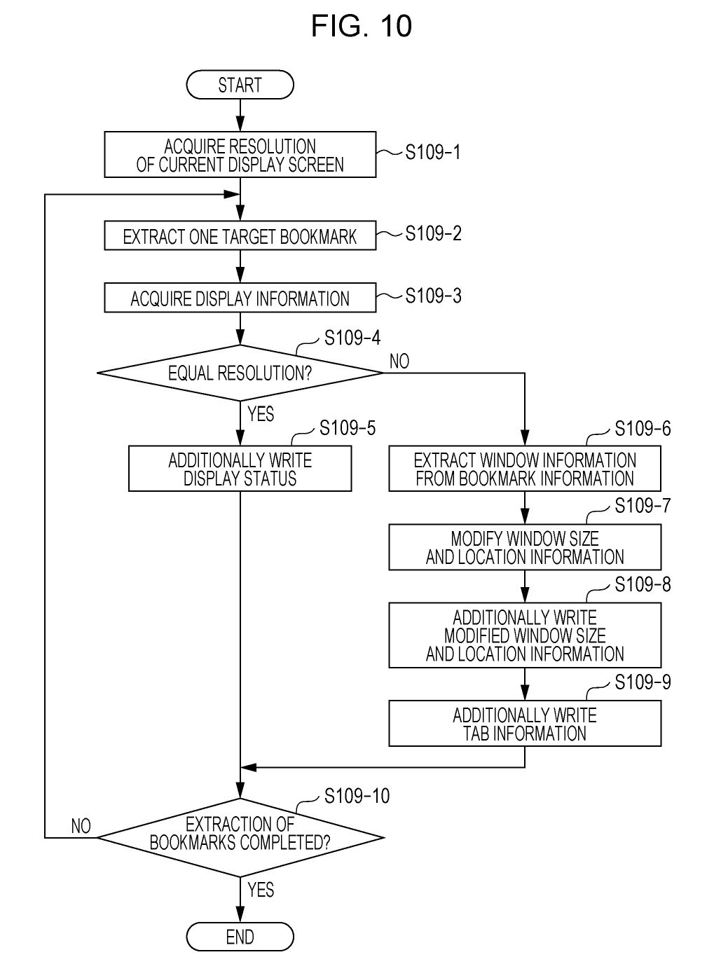

FIG. 10 is a flowchart illustrating the operation in step S109 of FIG. 8 in more detail.

The registering unit 13 acquires information of the resolution of the current display screen 21 (step S109-1).

The registering unit 13 extracts a bookmark as a target, based on the selection information of bookmarks acquired in step S102 (step S109-2).

The registering unit 13 acquires the display information from the display status registered on the extracted bookmark (step S109-3). The display information includes resolution as size information of the registered display screen 21.

The registering unit 13 compares the resolution of the current display screen 21 acquired in step S109-1 equals the resolution of the display screen 21 registered on the bookmark acquired in step S109-2 (step S109-4).

If the resolution of the current display screen 21 equals the resolution of the registered display screen 21 (yes branch from S109-4), the registering unit 13 additionally writes the display status to the bookmark information (step S109-5). The display status is the one described with reference to FIG. 6.

If the resolution of the current display screen 21 is not equal to the resolution of the registered display screen (no branch from S109-4), the registering unit 13 extracts the window information from the display status registered on the bookmark (step S109-6).

Based on the resolution of the current display screen 21, and the resolution acquired in step S109-3, the display status modifying unit 14 modifies the display status acquired in step S108 through the method described with reference to FIG. 7 in view of the resolution registered on the bookmark. More specifically, the display status modifying unit 14 modifies the location information and the window size of the window information (step S109-7).

The registering unit 13 additionally writes the modified window size and location information to the bookmark information (step S109-8).

The registering unit 13 also additionally writes the tab information to the bookmark information (step S109-9).

Subsequent to step S109-5 or step S109-9, the registering unit 13 determines whether all bookmarks are extracted as targets (step S109-10).

If not all bookmarks are extracted (no branch from S109-10), the registering unit 13 returns to step S109-2.

If all bookmarks are extracted (yes branch from S109-10), the registering unit 13 ends the operation in step S109.

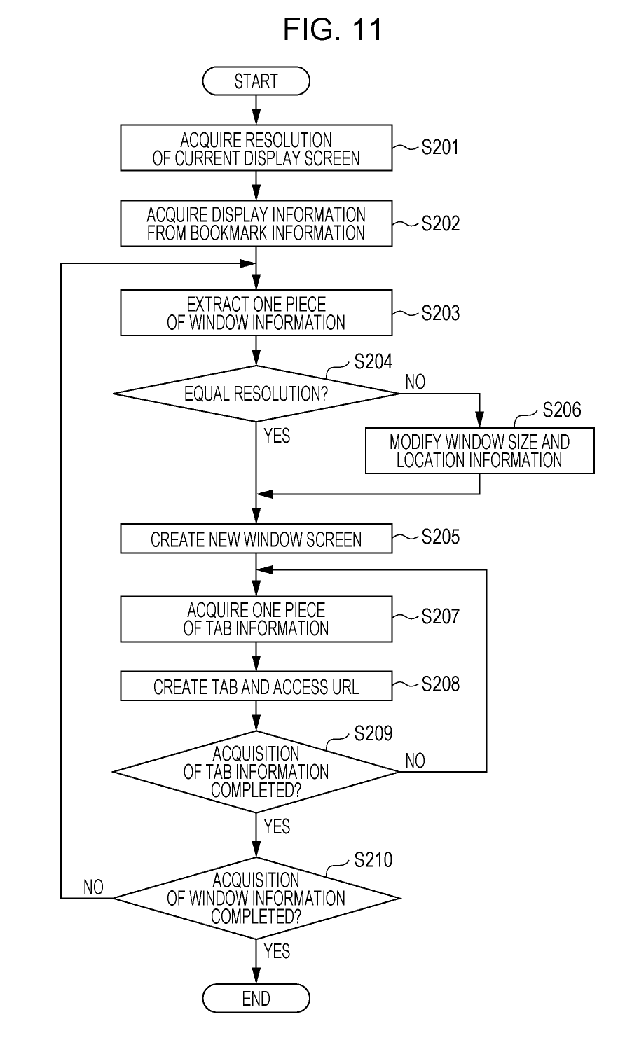

FIG. 11 is a flowchart illustrating the process which restores and displays window screens and tab screens in accordance with the display status registered on the information of bookmarks, from among the processes of the information processing apparatus 10.

The restoring unit 15 acquires information of the resolution of the current display screen 21 (step S201).

The restoring unit 15 then acquires the display information from the display status registered in the bookmark information (step S202). The display information includes the resolution as the information of the size of the display screen 21 registered in step S110 of FIG. 8.

The restoring unit 15 extracts one piece of the window information included in the display status (step S203).

The restoring unit 15 determines whether the resolution of the current display screen 21 acquired in step S201 equals the resolution of the display screen 21 registered on the bookmark acquired in step S202 (step S204).

If the resolution of the current display screen 21 equals the resolution of the display screen 21 registered on the bookmark (yes branch from S204), the restoring unit 15 creates a new window screen, based on the display status registered in the bookmark information (step S205).

If the resolution of the current display screen 21 does not equal the resolution of the display screen 21 registered on the bookmark (no branch from S204), the display status modifying unit 14 modifies the display status registered in the bookmark information in view of the resolution of the current display screen 21 through the method described with reference to FIG. 7, based on the resolution of the current display screen 21 acquired in step S201 and the resolution acquired in step S202. More specifically, the display status modifying unit 14 modifies the window size in the window information and the location information (step S206).

Subsequent to step S206, processing proceeds to step S205, and a new window screen is created based on the modified display status.

The restoring unit 15 acquires one piece of the tab information from the display status registered in the bookmark information (step S207).

The restoring unit 15 creates a tab, accesses a URL included in the tab information, and acquires content of webpage (step S208).

The restoring unit 15 determines whether all tab information has been acquired (step S209).

If not all tab information has been acquired (no branch from S209), processing returns to step S207.

If all tab information has been acquired (yes branch from S209), the restoring unit 15 determines whether all window information has been acquired (step S210).

If not all window information has been completed (no branch from S210), processing returns to step S203.

If all window information has been completed (yes branch from S210), the process ends.

The information processing apparatus 10 registers plural window screens and tab screens in the registration unit of a single bookmark. If the user selects one registration unit, the plural window screens and tab screens providing a service desired by the user are restored and displayed.

When plural window screens are laid out, and combined, a display status more appropriate for a combination thereof may be stored and restored.

A browser is described as an example of the application software, but the present invention is not limited to the browser. Groupware may be employed as the application software. The registration unit includes, but is not limited to a bookmark. The registration unit may be any module as long as the module has a storage functionality of the display status.

The process performed by the information processing apparatus 10 of the exemplary embodiment described above may be prepared as an application software program of a browser, for example.

In accordance with the exemplary embodiment, the process of the information processing apparatus 10 may be understood as a program causing a computer to execute a process for processing information. The process includes receiving selection information indicating that a user has selected plural window screens and/or tab screens, acquiring a display status regarding each of the selected window screens and/or tab screens, and restoring and displaying each of the window screens and/or tab screens in the display status when the user selects a registration unit that has registered the acquired display statuses.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a selection information receiving unit that receives selection information indicating that a user has selected a plurality of window screens and/or tab screens;
a display status acquisition unit that acquires a display status regarding each of the selected window screens and/or tab screens; and
a restoring unit that restores and displays each of the window screens and/or tab screens in the display status when the user selects a registration unit that has registered each of the acquired display statuses.

2. The information processing apparatus according to claim 1, wherein the registration unit is a bookmark.

3. The information processing apparatus according to claim 2, wherein the display status is registered in association with a registered bookmark.

4. The information processing apparatus according to claim 1, further comprising a display status modifying unit that modifies the display status in response to a display that displays the window screen and/or tab screen.

5. The information processing apparatus according to claim 4, wherein the display status modifying unit modifies the display status in accordance with a size of the display.

6. A display comprising:
an entry screen that receives selection information indicating that a user has selected a plurality of window screens and/or tab screens; and
a restoration screen into which the selected window screens and/or tab screens are restored in a display status used when the window screens and/or tab screens are selected.

7. The display according to claim 6, wherein the entry screen displays a screen on which the window screen and/or tab screen is registered in accordance with a registered bookmark.

8. A display system comprising:
a display that displays a plurality of window screens and/or tab screens; and
an information processing apparatus that performs control to restore and display window screens and/or tab screens that a user has selected from among the plurality of window screens and/or tab screens displayed on the display,
wherein the information processing apparatus includes
a selection information receiving unit that receives selection information indicating that the user has selected the window screens and/or tab screens,
a display status acquisition unit that acquires a display status regarding each of the selected window screens and/or tab screens, and
a restoring unit that restores and displays each of the window screens and/or tab screens in the display status when the user selects a registration unit that has registered the acquired display statuses.

9. A non-transitory computer readable medium storing a program causing a computer to execute a process for processing information, the process comprising:
receiving selection information indicating that a user has selected a plurality of window screens and/or tab screens;
acquiring a display status regarding each of the selected window screens and/or tab screens; and
restoring and displaying each of the window screens and/or tab screens in the display status when the user selects a registration unit that has registered the acquired display statuses.
